(19) United States
(12) Patent Application Publication
(10) Pub. No.: US 2007/0095583 A1
(43) Pub. Date: May 3, 2007

(54) Apparatus for driving a vehicle

(76) Inventor: Jong Hoon Lee, Hwaseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/300,160

(22) Filed: Dec. 13, 2005

(30) Foreign Application Priority Data
Oct. 31, 2005 (KR) 2005-0103409

(51) Int. Cl. B60K 6/00

(52) U.S. Cl. 180/65.2

(57) ABSTRACT

An apparatus for driving a vehicle is mounted in a general vehicle or a hybrid vehicle so as to play the roles of a transmission, a generator, and a differential gear in the vehicle, thereby decreasing the number of parts in a power transmission system for driving the vehicle, improving a layout of the vehicle, and reducing the manufacturing cost and the weight of the vehicle.

### CROSS-REFERENCE TO RELATED APPLICATION

This application claims priority to and the benefit of Korean Patent Application 10-2005-0103409 filed in the Korean Intellectual Property Office on Oct. 31, 2005, the entire content of which is incorporated herein by reference.

### BACKGROUND OF THE INVENTION

1. Field of the Invention

The present invention relates to an apparatus for driving a vehicle, and more particularly to an apparatus for driving a vehicle which is mounted into a general vehicle or a hybrid vehicle so as to play the roles of a transmission, a generator, and a differential gear in the vehicle, thereby decreasing the number of parts in a power transmission system for driving the vehicle, improving the layout of the vehicle, and reducing the manufacturing cost and the weight of the vehicle.

2. Description of the Related Art

Generally, a generator mounted in a vehicle refers to a device converting mechanical energy into electric energy.

Meanwhile, an electric motor refers to a device that converts electric energy into mechanical energy, and has a structure similar to a generator excepting for positions of a stator and a rotor.

The generator has a magnet disposed at a periphery thereof to generate magnetic field and has a conductor rotatably disposed in the magnet so as to regulate the magnetic field, thereby generating electromotive force.

Intensity of the electromotive force is in proportion to intensity of the magnetic field, the length of the conductor, and relative velocity between the magnet and the conductor. The direction of the electromotive force is determined by Fleming's right-hand rule.

Recently, a hybrid vehicle has been developed in addition to a gasoline engine vehicle and a diesel engine vehicle.

The hybrid vehicle refers to a vehicle in which two different power sources are efficiently associated. Typically, the hybrid vehicle includes an internal engine in which combustible fuel is used to generate power, and an electric motor using electricity to generate power.

When starting the hybrid vehicle, to operate an engine of the hybrid vehicle in a parking or stopping state, the hybrid vehicle uses the electric motor in order to minimize consumption of the fuel and generation of exhaust gas in the initial stage and uses the electric motor to support the power of the engine at a constant speed when the hybrid vehicle is accelerated along a road.

That is, the hybrid vehicle drives using electric power at a low speed, while operates using the fuel component at intermediate and high speeds. During a general movement of the hybrid vehicle, when moving at higher speed than a specific speed, the hybrid vehicle uses the gasoline instead of the electricity. Furthermore, the hybrid vehicle operates the electric motor to release load of the engine and to improve operation conditions.

Since the above-mentioned hybrid vehicle has its weight remarkably reduced so as to minimize air resistance, there is an advantage in that it is possible to increase its fuel consumption ratio as well as to reduce the exhaust amount of harmful gases. As a result, researches to improve the hybrid vehicle have been continued.

The common vehicle or the hybrid vehicle includes a generator, a driving motor, and a transmission. Meanwhile, since most vehicles use the driving motor as a power source of the vehicles, a separate transmission must be additionally mounted at a side of the driving motor.

However, in order to avoid the use of the additional transmission, a transmission including planet gears is installed between the engine and the driving motor. Thus, this causes the power transmission system to have an increased size while increasing the manufacturing cost and the weight of the vehicle. Thus, there is a disadvantage in that the fuel consumption ratio of the vehicle deteriorates.

### SUMMARY OF THE INVENTION

Accordingly, the present invention has been developed in order to solve the above-mentioned problems occurring in the prior art, and an object of the present invention is to provide an apparatus for driving a vehicle, which is capable of playing the roles of a transmission, a generator, and a differential gear in a general vehicle or a hybrid vehicle, thereby reducing the manufacturing cost of the vehicle, realizing the compactness of the vehicle, and improving the layout of the vehicle.

In order to accomplish the object of the present invention, according to the present invention, a driving portion is installed to a vehicle, which transmits power from an engine to wheels and plays the roles of a generator, a transmission, and a differential gear in the vehicle.

The driving portion includes a ring gear receiving the power from the engine, and an internal gear which receives the power through the ring gear and has a coil wound several times thereon.

A planet gear portion is engaged with the internal gear, while a planet carrier is linked with the planet gear portion and formed with a permanent magnet. A differential gear is engaged with the planet gear portion.

A speed sensor is mounted on an exterior surface of the driving portion, and a controller is connected to the driving portion to control the driving portion.

### BRIEF DESCRIPTION OF THE DRAWINGS

The above and other objects, features, and advantages of the present invention will be more apparent from the following detailed description taken in conjunction with the accompanying drawings, in which:

FIG. 1 is a cross sectional view showing an apparatus for driving a vehicle according to the present invention;

FIG. 2 is a longitudinal sectional view showing the apparatus for driving the vehicle according to the present invention;

FIGS. 3A and 3B are views showing apparatuses for driving the vehicle according to the present invention, in which FIG. 3A shows the apparatuses for driving the vehicle which are mounted on a front axle, a rear axle, and a propeller shaft of a four-wheel drive type vehicle and FIG. 3B shows the apparatuses for driving the vehicle which are mounted on a front axle and a rear axle of a front-wheel drive type vehicle; and

FIGS. 4A and 4B are views showing operations of the apparatuses for driving the vehicle according to the present invention.

### DETAILED DESCRIPTION OF THE PREFERRED EMBODIMENTS

Hereinafter, a preferred embodiment of the present invention will be described with reference to the accompanying drawings.

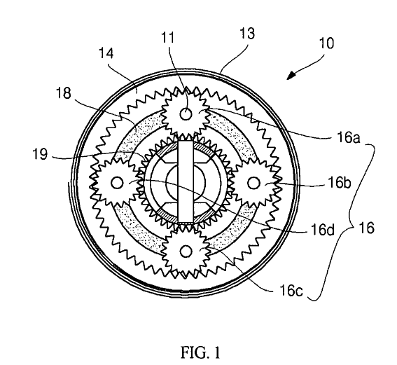

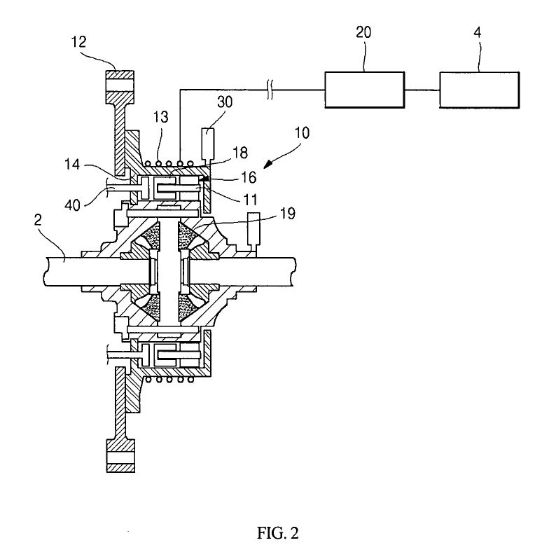

Referring to FIGS. 1 and 2, a driving portion 10 is installed to a vehicle, which transmits power from an engine (not shown) to wheels (not shown) while playing the roles of a generator, a transmission, and a differential gear.

The driving portion 10 includes a ring gear 12 receiving the power from the engine, and an internal gear 14 which receives the power through the ring gear 12 and has a coil 13 wound several times thereon.

A planet gear portion 16 is rotatably disposed on an inner peripheral surface of the internal gear 14, so as to engage with teeth of the internal gear 14. The planet gear portion 16 is the internal gears 14 and the differential gear 19.

A planet carrier 18 is formed with a permanent magnet, so as to be linked with the planet gear portion 16. The differential gear 19 acts as a stator.

The planet gears 16a, 16b, 16c, and 16d of the planet gear portion 16 are respectively installed to the planet carrier 18 by means of rotation shafts 11.

The differential gear 19 engaged with the planet gear portion 16 is directly connected to axle shafts 2 rotatably supporting the wheels.

The planet carrier 18 is rotatably operated by current applied to the coil 13.

Brakes 40 are installed near a side of the planet carrier 18, so as to be capable of coming in close contact with the planet carrier 18 to restrain rotation of the planet carrier 18.

A controller 20 is installed near the driving portion 10 in order to control the driving portion 10. The controller 20 is electrically connected with a battery 4 disposed in the vehicle.

The driving portion 10 includes a speed sensor 30 mounted on an exterior surface thereof. The speed sensor 30 senses a rotation speed of the ring gear 12, and transfers a sensed signal to the controller 20.

Hereinafter, an operation of the apparatus for driving the vehicle according to the present invention will be described with reference to drawings.

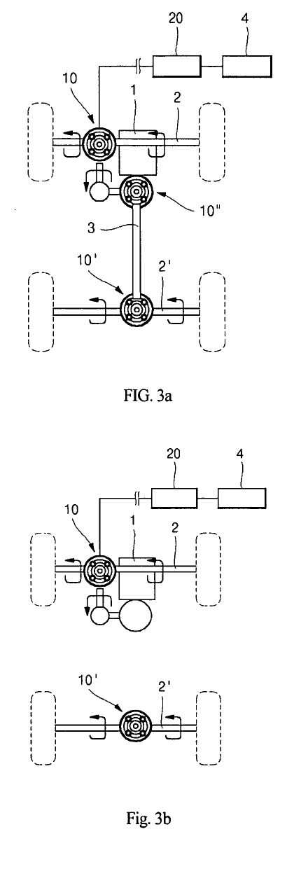

FIGS. 3A and 3B are views showing apparatuses for driving the vehicle, which are mounted in the vehicle, according to the present invention, in which FIG. 3A shows the apparatuses for driving the vehicle which are mounted on a front axle, a rear axle, and a propeller shaft of a four-wheel drive type vehicle and FIG. 3B shows the apparatus for driving the vehicle which are mounted on a front axle and a rear axle of a front-wheel drive type vehicle.

Referring to FIG. 3A, the driving portion 10 is connected to axle shafts 2 supporting the wheels in order to transmit the power from the engine 1 to the wheels.

The controller 20 is connected to the driving portion 10, while being electrically connected to the battery 4.

Further, a driving portion 10′ is mounted on rear axle shafts 2′ supporting rear wheels. Meanwhile, a separate driving portion 10″ is installed between the driving portion 10 mounted on the front-wheels and the driving portion 10′ mounted on the rear wheels, and connected to the driving portions 10 and 10′ by means of propeller shafts 3.

Referring to FIG. 3B, the driving portion 10 is connected to the front axle shafts 2 in order to transmit the power from the engine 1 to the front-wheels.

The controller 20 is connected to the driving portion 10, while being electrically connected to the battery 4.

Further, the driving portion 10′ is connected to the rear axle shafts 2′ supporting the rear wheels, but operated separately from the driving portion 10 mounted on the front axle shafts 2.

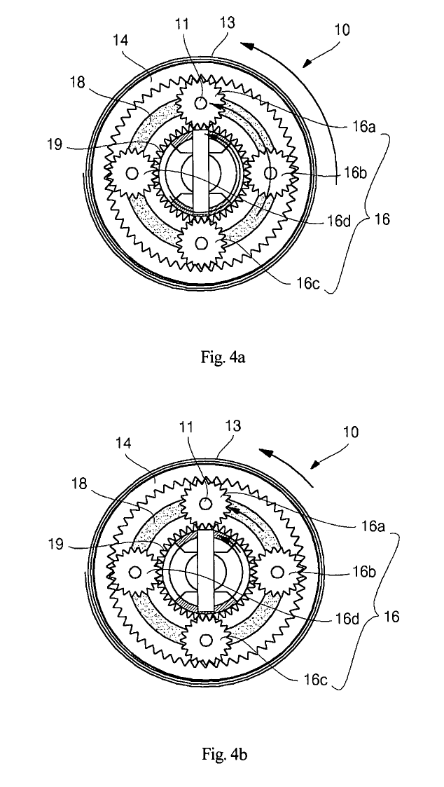

Hereinafter, an operation of the driving portion used as a transmission will be described with reference to FIG. 4A, according to the present invention.

FIG. 4A is a view showing the driving portion operating as a transmission of the vehicle.

When a driver getting in the vehicle (not shown) starts the engine 1 (see FIG. 3A), the power is transmitted from the engine 1 to the ring gear 12 (see FIG. 2).

The ring gear 12 is rotated by the power transmitted from the engine 1. The speed sensor 30 senses the rotation speed of the ring gear 12 and transfers the sensed signal to the controller 20, during the rotation of the ring gear 12.

At the same time, the controller 20 controls the current to be applied to the coil 13 wound on the driving portion 10, based on the transferred signal.

The coil 13 is several times wound on an exterior peripheral surface of the internal gear 14, and generates magnetic field when the current is applied to the coil 13.

The planet carrier 18 mounted in the driving portion 10 is formed with a permanent magnet, which rotates due to the magnetic field generated by the coil 13.

When the planet carrier 18 rotates, the planet gears 16a, 16b, 16c, and 16d engaging with the planet carrier 18 rotate along the inner peripheral surface of the internal gear 14 while the differential gear 19 engaging with the planet gears 16a, 16b, 16c, and 16d is rotated in a direction indicated by an arrow.

As the differential gear 19 is rotated, the axle shafts 2 (see FIG. 2) connecting to the differential gear 19 are also rotated, which make the wheels mounted on one end of the axle shafts 2 rotate, thereby operating the vehicle.

In order to reduce the speed of the vehicle during the operation of the vehicle, when the driver operates a transmission lever (not shown), the planet gears 16a, 16b, 16c, and 16d stop the their rotation and only the differential gear 19 is rotated so as to reduce the speed of the vehicle.

Hereinafter, an operation of the driving portion 10 used as a generator will be described with reference to FIG. 4B, according to the present invention.

Referring to FIG. 4B, in the case where the vehicle is moved only by inertia, when the vehicle moves down along a slope road, the wheels rotate along the slope road while the axle shafts 2 are also rotated.

When the axles shafts 2 are rotating, the differential gear 19 connected to the axle shafts 2 rotates and enables the planet gears 16a, 16b, 16c, and 16d engaging with the differential gear 19 to rotate.

As the planet gears 16a, 16b, 16c, and 16d are rotated, the planet carrier 18 to which the planet gears 16a, 16b, 16c, and 16d are rotatably fixed by the rotation shafts 11 is rotated. When the planet carrier 18 rotates, the electric current is induced to the coil 13 wound on the internal gear 14, which is transmitted to and stored in the battery 4 (see FIG. 2) or an alternator (not shown).

The speed sensor 30 (see FIG. 2) continuously senses the rotation speed of the ring gear 14 and transfers the sensed signal to the controller 20 (FIG. 2). The controller 20 controls the electric current to be applied to the coil 13 in order to perform a preferable change of the speed of the vehicle, thereby making the vehicle drive in an optimal state.

The brakes 40 (see FIG. 2) disposed at a side of the planet carrier 18 are used to control the speed of the planet carrier 18 in the case of requiring a control of the speed of the vehicle.

As described above, since the apparatus for driving the vehicle according to the present invention can play the roles of a generator, a transmission, and a differential gear, the total manufacturing cost of the vehicle can be reduced.

Further, the differential gear involved in the driving portion is directly connected to the axle shafts, so as to improve a recycling efficiency of energy and to reduce structural elements constituting the power transmission system. Thus, there is an advantage in that it is possible to improve the layout of the vehicle and to lighten the vehicle.

Furthermore, since the driving portion is mounted in the hybrid vehicle so as to act as an electric motor supporting the power, there is an advantage in that the hybrid vehicle can be compacted with the removal of the electric motor.

While an embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for driving a vehicle comprising:
a driving portion for transmitting power from an engine to wheels, the driving portion playing roles as a generator, a transmission, and a differential gear of the vehicle;
a speed sensor mounted on an exterior surface of the driving portion; and
a controller for controlling the driving portion, the controller being connected to the driving portion.

2. The apparatus for driving the vehicle as claimed in claim 1, wherein the driving portion includes: a ring gear for receiving the power from the engine; an internal gear for receiving the power through the ring gear, the internal gear having a coil wound several times thereon; planet gear portion engaged with the internal gear; planet carrier linked with the planet gear portion and formed with a permanent magnet; and a differential gear engaged with the planet gear portion.

3. The apparatus for driving the vehicle as claimed in claim 2, wherein the planet carrier is rotatably operated by current applied to the coil.

4. The apparatus for driving the vehicle as claimed in claim 2, wherein brakes are mounted to the internal gear near a side of the planet carrier to come in close contact with the planet carrier, so as to restrain a rotation of the planet carrier.

5. The apparatus for driving the vehicle as claimed in claim 2, wherein the differential gear includes axle shafts directly connected to the wheels.

6. The apparatus for driving the vehicle as claimed in claim 2, wherein the speed sensor senses a rotation speed of the ring gear and transmits a sensing signal to the controller.
